(19) United States
(12) Patent Application Publication
(10) Pub. No.: US 2022/0196166 A1
(43) Pub. Date: Jun. 23, 2022

(54) L-BALL UNION DRAIN VALVE

(71) Applicant: NIBCO Inc., Elkhart, IN (US)

(72) Inventors: Christopher W. Mason, Granger, IN (US); Lisa Lyon, North Grafton, MA (US)

(73) Assignee: NIBCO Inc., Elkhart, IN (US)

(21) Appl. No.: 17/126,104

(22) Filed: Dec. 18, 2020

(51) Int. Cl. F16K 11/087; F16K 5/06; F16K 27/06

(52) U.S. Cl. CPC F16K 11/0873; F16K 27/067; F16K 5/0605

(57) ABSTRACT

An L-ball union drain valve member utilizes a union member with an L-ball valve that is coupled to a tee-shaped valve body with a drain port. The drain port includes an additional valve member that permits the draining/purging/filling of the drain port. The orientation of the drain port can permit the draining/purging/filling of different sections of the valve assembly, depending upon orientation of the components. The union connection permits easy disassembly and installation of the components and differing position of the handle of the valve member with respect to the tee-shaped valve body.

### BACKGROUND OF THE INVENTION

The present invention relates to a drain valve. Valves incorporating drains can be used to drain all or part of the plumbing components near the drain valve. Drain valves can be used in a variety of plumbing applications, including, but not limited to, potable plumbing or hydronic heating systems. Drain valves that are incorporated into a system typically permit draining either above or below the valve by a drain segment that was positioned, as a separate component, above or below the drain valve. A number of components are typically necessary to couple a drain, a valve, and other piping unions when branch assemblies lead to and from the valve. This typically includes at least one segment of piping in between the drain, valve, piping union, and/or additional other components. This creates additional leak paths, takes additional time to assembly, and takes space given the number of components.

An improved assembly that eliminates a number of components and potential leak paths, while saving assembly time, labor, and space, is described herein.

### SUMMARY OF THE INVENTION

One aspect of the present invention is a valve assembly that includes a tee-shape valve body having a fluid passageway between a first fitting end, a drain port section, and a union end. The union end of the tee-shaped valve body is located in between the first fitting end and the drain port section of the tee-shaped valve body. The valve assembly includes a union member that is coupled to the union end of the tee-shaped valve body. The union member includes a union end and a second fitting end. The valve assembly includes a first valve member located on the union member between the union end and the second fitting end. The first valve member opens the fluid passageway between the second fitting end and the union end of the union member in a first position, while closing the fluid passageway between the second fitting end and the union end of the union member when in the second position. The valve assembly also includes a second valve member that is located in the drain port section of the tee-shaped valve body. A coupling member couples the union end of the union member and the union end of the tee-shaped valve body. At least one seal member is located between the union end of the union member and the union end of the tee-shaped valve body.

Yet another aspect of the present invention is a drain valve with a tee-shaped valve body having a fluid passageway between a first fitting end, a drain port section, and a union end. The union end of the tee-shaped valve body is located in the portion of the tee-shaped valve body that is at an approximate 90° angle from the first fitting end. The drain valve includes a union member coupled to the union end of the tee-shaped valve body. The union member includes a union end and a second fitting end. A first valve member is located on the union member between the union end and the second fitting end, while a second valve member is located in the drain port section of the tee-shaped valve body. At least one seal member is located between the union end of the valve body and the union end of the tee-shaped valve body, with a coupling member that couples the union end of the union member and the union end of the tee-shaped valve body.

Yet another aspect of the present invention is a piping system with a ball drain valve. The ball drain valve includes a tee-shaped valve body having a fluid passageway between a first fitting end, a drain port section, and a union end located in between the first fitting end and the drain port section. The ball drain valve includes a union member coupled to the union end of the tee-shaped valve body. The union member includes a union end and a second fitting end. A first valve member is located on the union member. At least one seal member is located between the union end of the union member and the union end of the tee-shaped valve body, with a coupling member that couples the union end of the union member and the union end of the tee-shaped valve body. A first pipe is coupled to the first fitting end of the tee-shaped valve body, while a second pipe is coupled to the second fitting end of the union member.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a front view of one embodiment of an L-ball union drain valve according to one aspect of the present invention;

FIG. 2 is a bottom view of the L-ball union drain valve shown in FIG. 1;

FIG. 3 is a front view of the L-ball union drain valve shown in FIG. 1 with the drain port in a generally horizontal orientation positioned above the union member;

FIG. 4 is a front view of the L-ball union drain valve shown in FIG. 1 with the drain port in a generally horizontal orientation positioned below the union member; and

FIG. 5 is a front view of another embodiment of an L-ball drain valve with a different orientation of the drain valve.

### DETAILED DESCRIPTION

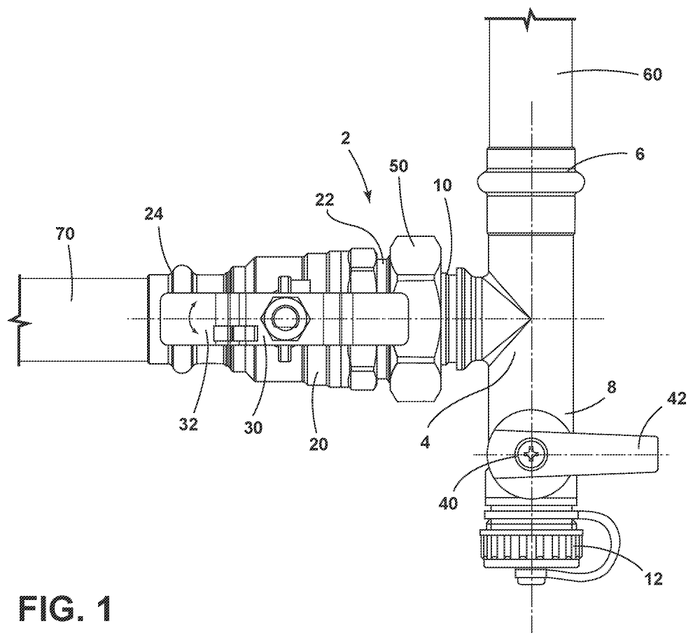

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. Indeed, other exemplary orientations are shown in the Figures. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

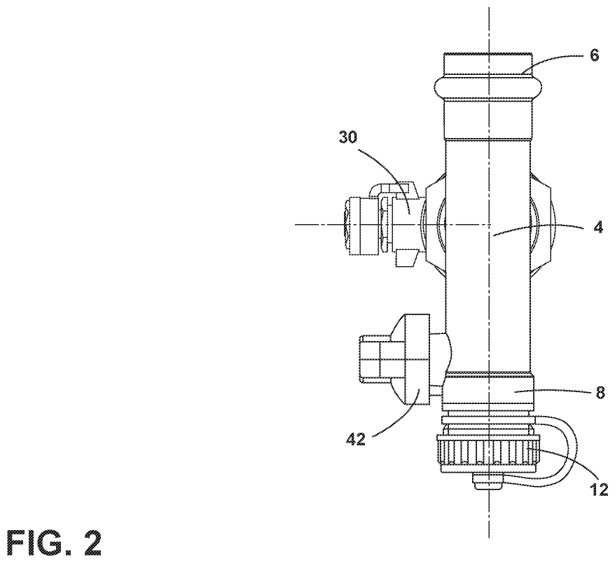

By way of overview, the present invention is generally directed to a drain valve assembly 2. The valve assembly 2 includes a tee-shaped valve body 4. The tee-shaped valve body 4 includes a first fitting end 6, a drain port section 8, and a union end 10. The first fitting end 6 and the drain port section 8 are generally aligned on the tee-shaped valve body 4 such that the first fitting end 6 and the drain port section 8 are approximately 180° apart, as shown in FIGS. 1-4. The union end 10 is located in the middle portion of the tee-shaped valve body 4, i.e., in between the first fitting end 6 and the drain port section 8. The union end 10 is located at approximately 90° from both the first fitting end 6 and the drain port section 8. Thus, the fluid passageway through the union end 10 would intersect the fluid passageway running in between the first fitting end 6 and the drain port section 8 at approximately a 90° angle. While the union end 10 is shown approximately equidistance in between the first fitting end 6 and drain port section 8, the union end 10 can be positioned closer to either the first fitting end 6 or the drain port section 8.

The drain valve assembly 2 also includes a union member 20. The union member 20 includes a union end 22 and a second fitting end 24. The union end 22 is coupled to the union end 10 of the tee-shaped valve body 4 via a coupling member 50. One or more sealing members (not shown) can be positioned between the surfaces of the union end 10 of tee-shaped valve body 4 and the union end 22 of union member 20. The sealing member(s) can include compressible seals, including, but not limited to, polymeric members such as rubber washers. In addition, the coupling member 50 can include internal threading (not shown) that couples to threading on the union end 22 of the union member 20 and/or threading on the union end 10 of tee-shaped valve body 4.

The valve assembly 2 includes a first valve member 30 that is located on union member 20. The first valve member 30 is positioned on union member 20 in between the union end 22 and the second fitting end 24 of union member 20. The first valve member 30 opens and closes the fluid passageway within union member 20 to permit or restrict flow between the union member 20 and the second fitting end 24. In the illustrated embodiment, the first valve member 30 is an L-ball valve member that is rotatable 90° between an open position and a closed position. The first valve member 30 can be actuated by handle 32.

A second valve member 40 is located on the drain port section 8 of the tee-shaped valve body 4. Second valve member 40 can open and close the fluid passageway within the tee-shaped valve body 4 leading to the drain port section 8. This permits the draining/purging/filling of the drain portion section 8. The drain port section 8 can include a cap 12 that is coupled to drain port section 8. Cap 12 can be coupled via threading engagement on drain port section 8 or through other coupling methods. The second valve member 40 can be actuated by handle 42.

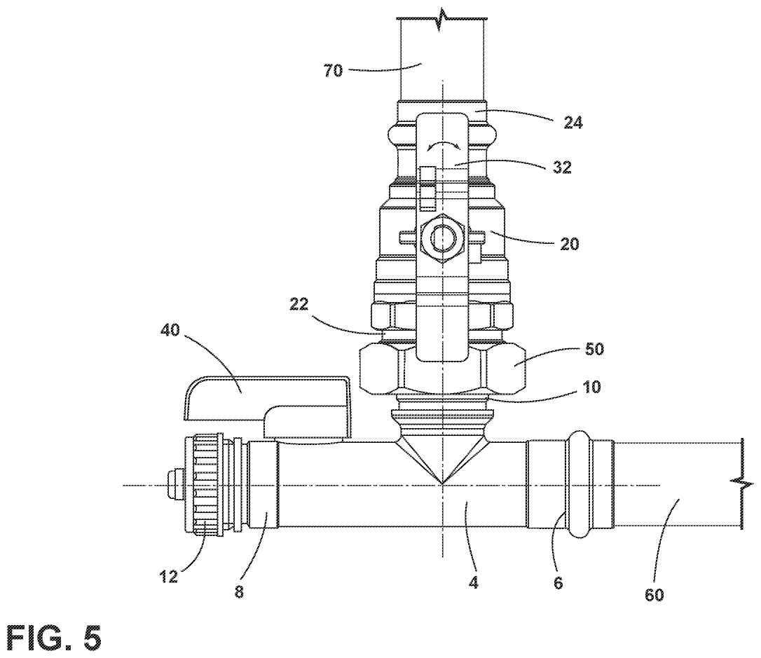

The second valve member 40 can be positioned on the same side of the valve assembly 2 as the first valve member 30. For example, in FIGS. 1-4, the second valve member 40 and first valve member 30 are both on the front side of the valve assembly 2. The second valve member 40 and first valve member 30 could also be located on the back side of the valve assembly 2. Alternatively, the second valve member 40 can be positioned on the top side of the drain port section 8, as shown in FIG. 5, while the first valve member 30 remains on the front side of the valve assembly 2. The arrangement shown in FIG. 5 is one example of the second valve member 40 and first valve member 30 not being on the same side. Alternating positions of the second valve member 40 and the first valve member 30 with respect to each other gives alternative options for installation. For example, the embodiment shown in FIG. 5 permits the drain port section 8 to be positioned on either the right or left side of the valve assembly 2 by rotation of the union member 20 with respect to the tee-shaped valve body 4. The union member 20 can thus be rotated prior to tightening to get the desired drain port section 8 orientation. The position of the second valve member 40 on the top side of the tee-shaped valve body 4, as shown in FIG. 5, allows the handle 42 of the second valve member 40 to be easily accessed regardless of whether the drain port section 8 is installed on the right side of the piping assembly, the left side, or in between.

The tee-shaped valve body 4 can be an integrally formed as a single piece as shown in the illustrated embodiments. However, the tee-shaped valve body 4 can alternatively include bonnets which form the first fitting end 6 and/or the drain port section 8 that are connected to the remainder of the tee-shaped valve body 4. Similarly, the union member 20 can be integrally formed as a single piece, as shown in FIGS. 1-4. However, union member 20 can alternatively include one or more bonnets for the union end 22 and/or second fitting end 24.

The first fitting end 6 of the tee-shaped valve body 4 and the second fitting end 24 of the union member 20 can be any type of fitting. In the illustrated embodiments, first fitting end 6 of the tee-shaped valve body 4 and the second fitting end 24 of the union member 20 are both press-fittings. However, the first fitting end 6 and the second fitting end 24 can be push-to-connect, press-to-connect, solder, PEX, fusion, female pipe thread, male pipe thread, or other types of plumbing fitting ends. In addition, the first fitting end 6 and the second fitting end 24 do not need to be the same type of fitting and/or the same size of fitting.

The tee-shaped valve body 4 can be made of a metallic material. In the illustrated embodiments, the tee-shaped valve body 4 is made from a material containing brass. Similarly, the coupling member 50 and the union member 20 can also be made of a metallic material. In the illustrated embodiments, the union member 20 and the coupling member 50 are also made from brass.

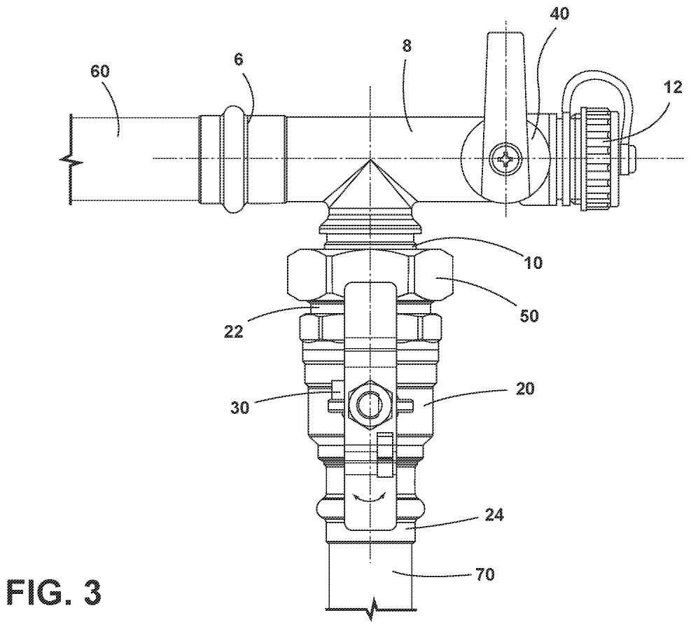

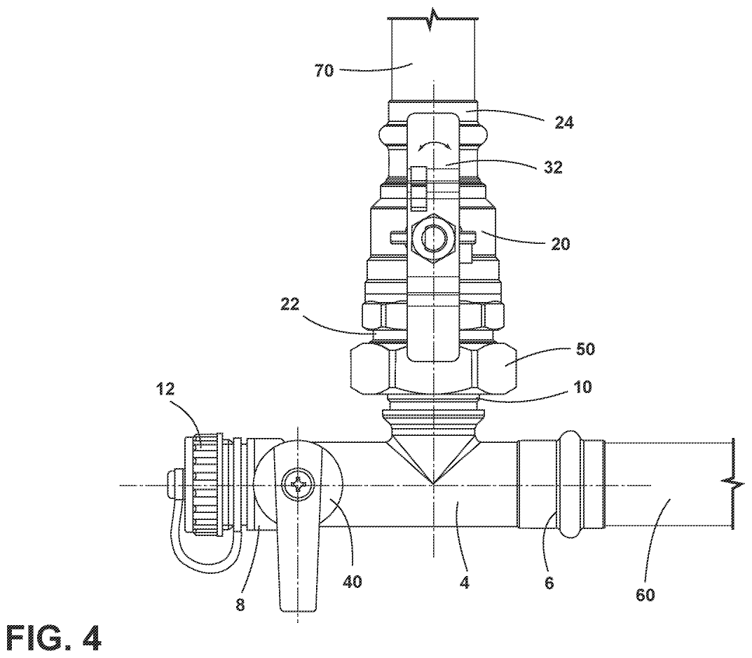

A pipe member 60 is coupled to the first fitting end 6 of the tee-shaped valve body 4, as illustrated in FIG. 1. Similarly, a pipe member 70 is coupled to the second fitting end 24 of union member 20, as illustrated in FIG. 1. The drain port section 8 can be positioned in a vertical orientation, as shown in FIG. 1, or in a horizontal configuration, as shown in FIGS. 3 and 4. Additionally, the drain port section 8 can be positioned above or below the union member 20. This gives alternative ways of draining the valve assembly 2 and associated plumbing components, including pipe members 60 and/or 70. Thus, the purging/filling/draining of either the vertical or horizontal run can be done depending upon installation orientation.

The union member 20 allows for quick and efficient disconnection from the pipe members 60 and/or 70 or attached appliances as needed. Moreover, the union member 20 permits the handle 32 on first valve member 30 to be easily rotated during installation to a place where the handle 32 is easily accessible. This is especially convenient in tight spaces where the handle 32 needs to be accessed. This also permits different respective positioning of the handle 32 of the first valve member 30 with respect to the tee-shaped valve body 4 and handle 42 of second valve member 40. Again, the ability to rotate the union member 20 during installation gives flexibility to the handle 32 positioning.

In the foregoing description, it will be readily appreciated by those skilled in the art that modifications may be made to the invention without departing from the concepts disclosed herein. Such modifications are to be considered as included in the following claims, unless these claims by their language expressly state otherwise.

It will be understood by one having ordinary skill in the art that construction of the present disclosure and other components is not limited to any specific material. Other exemplary embodiments of the disclosure disclosed herein may be formed from a wide variety of materials, unless described otherwise herein.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated. In addition, while certain embodiments have shown threaded connections, the threaded connections could include tape or other sealing material in the threaded connection. In addition, the threaded connection could be replaced by other suitable connections or couplings, such as compression couplings or other couplings.

For purposes of this disclosure, the term “connected” or “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the afore-mentioned structures and methods without departing from the concepts of the present invention, and further it is to be understood that such concepts are intended to be covered by the following claims unless these claims by their language expressly state otherwise.

1. A valve assembly, comprising:
a tee-shaped valve body having a fluid passageway between a first fitting end, a drain port section, and a union end located in between the first fitting end and the drain port section of the valve body;
a separate union member, coupled to said union end of said tee-shaped valve body, said union member including a union end and a second fitting end;
a first valve member located on said union end member between said union end and said second fitting end;
wherein said first valve member opens said fluid passageway between said second fitting end and said union end of the union member when in a first position, while closing said fluid passageway between said second fitting end and said union end of the valve member when in a second position;
a second valve member located in said drain port section in said tee-shaped valve body;
a coupling member that couples said union end of the union member and the union end of the tee-shaped valve body;
at least one seal member located between said union end of the union member and said union end of the tee-shaped valve body; and
wherein the handle of said first valve member and the handle of said second valve member are positioned on the same side of said tee-shaped valve body.

2. (canceled)

3. The valve assembly of claim 1, wherein said second valve member is a ball valve.

4. The valve assembly of claim 1, wherein said first fitting end on the tee-shaped valve body and the second fitting end on said union member are the same type of fitting.

5. The valve assembly of claim 1, wherein said drain port section and said first fitting end are in a generally horizontal orientation when said union is in a generally vertical orientation.

6. The valve assembly of claim 1, wherein said at least one seal member includes a rubber washer.

7. The valve assembly of claim 1, wherein said drain port section includes a capped end.

8. The valve assembly of claim 1, wherein said union member, said tee-shaped valve body, and said coupling member are made from a metallic material.

9. The valve assembly of claim 1, wherein said internal diameters of the first fitting end, the drain port section, and the second fitting end are not the same.

10. A drain valve, comprising:
a tee-shaped valve body having a fluid passageway between a first fitting end, a drain port section, and a union end located in the portion of the tee-shaped valve body that is at an approximate 90° angle from said first fitting end;
a separate union member coupled to said union end of said tee-shaped valve body, said union member including a union end and a second fitting end;
a first valve member located on said union member between said union end and said second fitting end;
a second valve member located in said drain port section;
a coupling member that couples said union end of the union member and said union end of the tee-shaped valve body;
at least one seal member located between said union end of the valve body and the union end of the tee body; and
wherein the handle of said first valve member and the handle of said second valve member are positioned on the same side of said tee-shaped valve body.

11. (canceled)

12. The drain valve of claim 10, wherein said seal member is a compressible washer.

13. The drain valve of claim 10, wherein said drain port includes a removable cap.

14. A piping system with a ball drain valve, comprising:
a tee-shaped valve body having a fluid passageway between a first fitting end, a drain port section with a drain valve member, and a union end located in between the first fitting end and the drain port section;
a separate union member coupled to said union end of said tee-shaped valve body, said union member including a union end and a second fitting end;
a first valve member located on said union member;
a coupling member that couples said union end of the union member and said union end of the tee-shaped valve body;
at least one seal member located between said union end of the union member and the union end of the tee-shaped valve body;
a first pipe coupled to said first fitting end on the tee-shaped valve body;
a second pipe coupled to said second fitting end on said union member; and
wherein the handle of said drain valve member and said first valve member are positioned on the same side of said tee-shaped valve body.

15. The piping system utilizing a ball drain valve of claim 14, including a second valve member located in said drain port section.

16. The piping system utilizing a ball drain valve of claim 14, wherein at least one of said first pipe and said second pipe has a different diameter from the other.

17. The piping system utilizing a ball drain valve of claim 14, wherein said coupling member is a nut.

18. (canceled)

19. The piping system utilizing a ball drain valve of claim 14, wherein said tee-shaped valve body is a unitary piece of metal.

20. The piping system utilizing a ball drain valve of claim 14, wherein said coupling member includes a compressed seal.
